(19) United States
(12) Patent Application Publication
(10) Pub. No.: US 2018/0209267 A1
(43) Pub. Date: Jul. 26, 2018

(54) Integrated Workflow For Feasibility Study Of Cuttings Reinjection Based On 3-D Geomechanics Analysis

(71) Applicant: Halliburton Energy Services, Inc., Houston, TX (US)

(72) Inventors: Xinpu Shen, Houston, TX (US); Williams B. Standifird, Fulshear, TX (US); Guoyang Shen, Houston, TX (US)

(21) Appl. No.: 15/744,538

(22) PCT Filed: Aug. 31, 2015
(86) PCT No.: PCT/US2015/047787

§ 371 Date: Jan. 12, 2018

(51) Int. Cl. E21B 49/00; G01V 1/30; G01V 1/28; E21B 43/26

(52) U.S. Cl. CPC E21B 49/005; E21B 49/006; E21B 43/26; G01V 1/282; G01V 1/302

(57) ABSTRACT

Methods and systems are presented in this disclosure for feasibility study of cuttings reinjection (CRI) process based on three-dimensional (3-D) geomechanical analysis. A location of an injection well for CRI can be first determined along with a true vertical depth (TVD) interval of an injection section along a trajectory of the injection well. Then, a window of values for an injection pressure for hydraulic fracturing performed in association with the injection well can be calculated. Analysis of fault reactivation due to the hydraulic fracturing can be performed, and a volume of a fracture generated by the hydraulic fracturing can be calculated. CRI for the volume of the fracture can be performed at the determined location of the injection well for the TVD interval, by taking into account the injection pressure window and the analysis of fault reactivation.

### TECHNICAL FIELD

The present disclosure generally relates to cuttings reinjection practice and, more particularly, to an integrated workflow for feasibility study of cuttings reinjection based on three-dimensional (3-D) geomechanical analysis.

### BACKGROUND

In the drilling of wells, a drill bit is used to dig many thousands of feet into the earth's crust. Oil rigs typically employ a derrick that extends above the well drilling platform. The derrick supports joint after joint of drill pipe connected end-to-end during the drilling operation. As the drill bit is pushed further into the earth, additional pipe joints are added to the ever lengthening “string” or “drill string”. Therefore, the drill string includes a plurality of joints of pipe.

Fluid “drilling mud” is pumped from the well drilling platform, through the drill string, and to a drill bit supported at the lower or distal end of the drill string. The drilling mud lubricates the drill bit and carries away well cuttings generated by the drill bit as it digs deeper. The cuttings are carried in a return flow stream of drilling mud through the well annulus and back to the well drilling platform at the earth's surface. When the drilling mud reaches the platform, it is contaminated with small pieces of shale and rock that are known in the industry as well cuttings or drill cuttings. Once the drill cuttings, drilling mud, and other waste reach the platform, a “shale shaker” is typically used to remove the drilling mud from the drill cuttings so that the drilling mud may be reused. The remaining drill cuttings, waste, and residual drilling mud are then transferred to a holding trough for disposal. In some situations, for example with specific types of drilling mud, the drilling mud may not be reused and it must be disposed. Typically, the non-recycled drilling mud is disposed of separate from the drill cuttings and other waste by transporting the drilling mud via a vessel to a disposal site.

The disposal of the drill cuttings and drilling mud (drilling waste) is a complex environmental problem. Drill cuttings contain not only the residual drilling mud product that would contaminate the surrounding environment, but may also contain oil and other waste that is particularly hazardous to the environment, especially when drilling in a marine environment.

One method of disposing of oily-contaminated cuttings is to re-inject the cuttings into the formation using cuttings reinjection (CRI) operation. The operations in CRI process typically include the identification of an appropriate stratum or formation for the injection; preparing an appropriate injection well; formulation of the slurry, which includes considering such factors as weight, solids content, pH, gels, etc.; performing the injection operations, which includes determining and monitoring pump rates such as volume per unit time and pressure; and capping the well.

The prior art references on CRI process typically address its operational aspects, such as well planning, designing surface devices, and controlling injection pressure. Fracture geometry can be optimized based on a simulated fracture generated for cuttings reinjection. Geomechanical modeling and analysis is also adopted for designing CRI process. One-dimensional (1-D) geomechanical analysis along with the stress contrast method can be applied in order to choose a true vertical depth (TVD) section of an injection point. Furthermore, hydraulic fracture analysis can be performed with a three-dimensional (3-D) planar fracture model. Various operational aspects of CRI process can be also related to slurry properties. Geomechanical analysis can be used for hydraulic fracturing simulation, and the front-end engineering design is adopted in designing CRI process. As one of the major tasks being performed in the CRI analysis, principle and techniques used in analysis of hydraulic fracturing of CRI is the same as that used in analysis of reservoir stimulation for tight gas and/or tight oil.

During CRI process, fault reactivation can be initiated by connecting stimulated fractures to a fault. Reactivation of the fault can result in environmental pollution due to fluid migration, particularly in an offshore field. Another environmental risk of injection-related fault reactivation is a scenario of induced seismic behavior. Fault reactivation related to hydraulic fracturing either by CRI or reservoir stimulation has been investigated in the past. Analytical methods were initially used, and numerical 3-D and/or quasi-3-D methods are increasingly popular in recent years due to development of computational technology.

Seismic behaviors associated with fault reactivation due to hydraulic fracturing related to either CRI or other purposes are investigated in the past. Analysis of seismic behavior involving porous flow and 3-D dynamic plastic behavior of faults is typically very complicated and time consuming. On the other hand, the pure analytical solution of seismic analysis related to fault reactivation is simple, but it does not provide satisfactory results.

Thus, it is desirable to develop a workflow for comprehensive feasibility study of CRI practice.

### BRIEF DESCRIPTION OF THE DRAWINGS

Various embodiments of the present disclosure will be understood more fully from the detailed description given below and from the accompanying drawings of various embodiments of the disclosure. In the drawings, like reference numbers may indicate identical or functionally similar elements.

FIG. 1 is a flowchart of an integrated workflow for feasibility study of cuttings reinjection (CRI) process based on three-dimensional (3-D) geomechanical analysis, according to certain embodiments of the present disclosure.

FIG. 2 is an example graph showing a brittle and ductile failure of a shale rock with variation of a shear stress, according to certain embodiments of the present disclosure.

FIG. 3 is an example graph of a brittleness index, according to certain embodiments of the present disclosure.

FIG. 4 is an example graph of injection pressure variation versus time for horizontal and vertical fractures, according to certain embodiments of the present disclosure.

FIG. 5 is a finite element model (FEM) for cap integrity estimation and numerical results, according to certain embodiments of the present disclosure.

FIG. 6 is an example graph comparison of curves of variation of injection pressure versus time for stable fracture propagation stage, according to certain embodiments of the present disclosure.

FIG. 7 is a flow chart of a method for performing feasibility study of CRI process, according to certain embodiments of the present disclosure.

FIG. 8 is a block diagram of an illustrative computer system in which embodiments of the present disclosure may be implemented.

### DETAILED DESCRIPTION

Embodiments of the present disclosure relate to an integrated workflow for feasibility study of cuttings reinjection (CRI) based on three-dimensional (3-D) geomechanical analysis. While the present disclosure is described herein with reference to illustrative embodiments for particular applications, it should be understood that embodiments are not limited thereto. Other embodiments are possible, and modifications can be made to the embodiments within the spirit and scope of the teachings herein and additional fields in which the embodiments would be of significant utility.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described. It would also be apparent to one skilled in the relevant art that the embodiments, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

The disclosure may repeat reference numerals and/or letters in the various examples or Figures. This repetition is for the purpose of simplicity and clarity and does not in itself dictate a relationship between the various embodiments and/or configurations discussed. Further, spatially relative terms, such as beneath, below, lower, above, upper, uphole, downhole, upstream, downstream, and the like, may be used herein for ease of description to describe one element or feature's relationship to another element(s) or feature(s) as illustrated, the upward direction being toward the top of the corresponding figure and the downward direction being toward the bottom of the corresponding figure, the uphole direction being toward the surface of the wellbore, the downhole direction being toward the toe of the wellbore. Unless otherwise stated, the spatially relative terms are intended to encompass different orientations of the apparatus in use or operation in addition to the orientation depicted in the Figures. For example, if an apparatus in the Figures is turned over, elements described as being “below” or “beneath” other elements or features would then be oriented “above” the other elements or features. Thus, the exemplary term “below” can encompass both an orientation of above and below. The apparatus may be otherwise oriented (rotated 90 degrees or at other orientations) and the spatially relative descriptors used herein may likewise be interpreted accordingly.

Moreover even though a Figure may depict a horizontal wellbore or a vertical wellbore, unless indicated otherwise, it should be understood by those skilled in the art that the apparatus according to the present disclosure is equally well suited for use in wellbores having other orientations including vertical wellbores, slanted wellbores, multilateral wellbores or the like. Likewise, unless otherwise noted, even though a Figure may depict an offshore operation, it should be understood by those skilled in the art that the apparatus according to the present disclosure is equally well suited for use in onshore operations and vice-versa. Further, unless otherwise noted, even though a Figure may depict a cased hole, it should be understood by those skilled in the art that the apparatus according to the present disclosure is equally well suited for use in open hole operations.

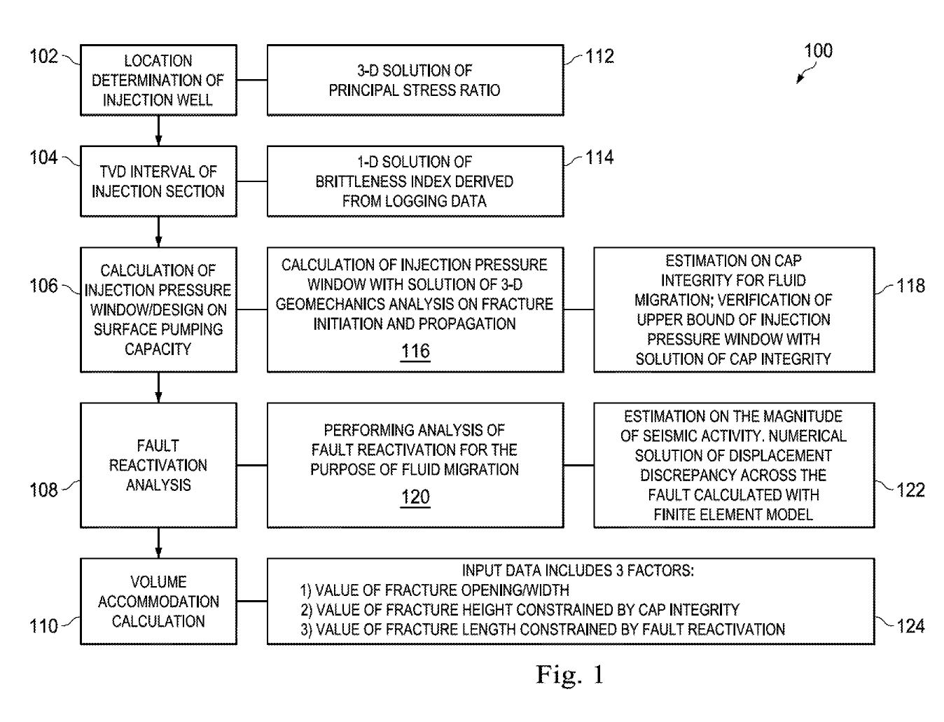

Illustrative embodiments and related methods of the present disclosure are described below in reference to FIGS. 1-8 as they might be employed for feasibility study of CRI process based on 3-D geomechanical analysis. Such embodiments and related methods may be practiced, for example, using a computer system as described herein. Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures are only exemplary and are not intended to assert or imply any limitation with regard to the environment, architecture, design, or process in which different embodiments may be implemented.

Embodiments of the present disclosure relate to an integrated workflow for feasibility study of CRI process on the basis of 3-D geomechanical analysis. For certain embodiments, solutions of geomechanical analysis provide basis for a feasibility study and/or design of CRI process. Solution of 3-D geostress distribution and the effective stress ratio described and discussed in more detail below are essential factors used in selection of a preferred location of an injection well. In one or more other embodiments, solution of one-dimensional (1-D) geomechanical analysis may provide a basis for choosing a true vertical depth (TVD) interval for injection sections.

During CRI process, hydraulic fractures can be created at a target formation and milled cuttings are injected with a fluid into the fractures. It is often required that CRI process remains in compliance with environmental regulations and ‘zero-discharge’ policies. Due to the policy of ‘zero discharge’, it is required that fluid migration is analyzed in the feasibility study and/or during the design of CRI. Consequently, cap integrity and fault reactivation are two essential tasks to be performed in CRI along with the hydraulic fracturing. In one or more embodiments, hydraulic fracturing performed in the framework of 3-D geomechanical analysis may provide an accurate solution for not only an injection pressure window, but also for analysis of fault reactivation related to CRI process and estimation of seismic behavior.

Embodiments of the present disclosure relate to improving certain aspects of the current CRI practice. For example, the choice of the location of injection well is currently made mostly on the information of geology, wherein a preferred geostress factor is not considered. However, as discussed in more detail below, the preferred geostress factor can significantly impact a quality of CRI operation. Furthermore, traditionally, the focus of hydraulic fracturing analysis is on determining values of a surface pumping pressure and/or the injection rate that would initiate the fracture, whereas an upper bound of the injection pressure is not calculated. Embodiments of the present disclosure are related to determining the upper bound of the injection pressure.

In the current CRI practice, estimation on fault reactivation risk is typically not regarded as an essential part of a workflow for feasibility study. This ignorance is not in accordance with the ‘zero discharge’ environmental policy. Embodiments of the present disclosure provide estimation on fault reactivation risk, as described in more detail below. Finally, embodiments of the present disclosure provide a novel integrated workflow that synthetically combines solution of 3-D geomechanical analysis with major tasks of feasibility study of CRI practice.

In one or more embodiments, the integrated workflow for feasibility study of CRI process presented herein may comprise the following operations: choice of a plane location of an injection well; choice of TVD interval for applying the injection; design of hydraulic fracturing, including determination of a proper injection rate and/or injection pressure; cap integrity estimation, which verifies safety of the injection pressure and injection rate under the constraint of ‘zero discharge’ environmental policy; fault reactivation analysis, which determines a length of generated fracture under the constraint of ‘zero discharge’ environmental policy; seismic analysis of fault reactivation; and determination of a volume of fluid with cuttings that can be injected at the chosen well location.

Embodiments of the present disclosure establish an integrated workflow for feasibility study of CRI practice. In one or more embodiments, solution of various mechanical variables obtained with 3-D geomechanical analysis at various levels of scale provide foundation for this usage. The aforementioned shortcomings of the prior art can be overcome with the integrated workflow presented herein. A systematic procedure of CRI practice can be established on the basis of solutions of 1-D and 3-D geomechanical analysis. In one or more embodiments, tools of 1-D and 3-D geomechanical analysis can be used as major theoretical tools for the feasibility study of CRI process presented herein.

FIG. 1 illustrates an example flowchart 100 of an integrated workflow for feasibility is study of CRI process based on 3-D geomechanical analysis, according to certain embodiments of the present disclosure. Blocks 102-110 of the integrated workflow 100 represent stages of presented CRI process, whereas blocks 112-124 of the integrated workflow 100 represent tasks of 3-D geomechanical analysis. In one or more embodiments, solutions of 3-D geomechanical analysis can be used for decision-making at various stages of CRI process. Application of 3-D geomechanical analysis is one of major characteristics of the integrated workflow 100 presented herein. In addition, as illustrated in FIG. 1, the conventional 1-D geomechanical analysis is also an integral part of the workflow 100 for feasibility study of CRI process.

At block 102 of the integrated workflow 100 in FIG. 1, the location of the injection well may be determined based on 3-D finite element calculation. At block 112 coupled with block 102, 3-D stress distribution within field formation may be calculated. Then, also at block 112, 3-D solution of principal stress ratio used as an index of a preferred stress may be calculated from the solution of 3-D stress distribution. In one or more embodiments, the principal stress ratio may be used for determining the location of injection well, at block 102.

At block 104 of the integrated workflow 100, TVD interval of injection section may be determined. At block 114 coupled with block 104, 1-D solution of brittleness index may be calculated based on logging data, such as sonic data and gamma ray data. As discussed in further detail below, the brittleness index calculated at block 114 may be utilized for determining the TVD interval of injection section, at block 104.

At block 106 of the integrated workflow 100, an injection pressure window (IPW) may be calculated. For certain embodiments, calculation of IPW may comprise two parts: calculation of a lower bound and calculation of an upper bound. In one or more embodiments, a value of the lower bound for IPW may be derived, at block 116 coupled with block 106, from solution of 3-D geomechanical analysis of hydraulic fracturing that focuses on fracture initiation and propagation. The derived value of lower bound for IPW may represent a value of injection pressure at the stage of stable fracture propagation. In one or more embodiments, a value of the upper bound for IPW represents a peak value of injection pressure with a proper injection rate. In general, the value of IPW upper bound may be also constrained by the cap integrity. At block 118, 3-D geomechanical analysis on cap integrity may be performed for purpose of analyzing fluid migration. Consequently, 3-D geomechanical analysis on cap integrity is an essential part of verification on cap integrity performed at block 118 of the integrated workflow 100.

At block 108 of the integrated workflow 100, analysis of fault reactivation may be performed. Quasi 3-D (e.g., two-dimensional (2-D) plane strain) finite element model may be used for the purpose of accuracy and efficiency in analyzing fault reactivation. First, at block 120 coupled with block 108 of the integrated workflow 100, analysis of fault reactivation for the purpose of fluid migration may be performed. Second, at block 122, seismic behavior resulted from fault reactivation may be analyzed. In one or more embodiments, the magnitude of seismic activity related to the fault reactivation may be estimated, at block 122. For example, the magnitude of the seismic activity may be calculated analytically. Further, for certain embodiments, numerical solution of displacement discrepancy across the fault may be also calculated using a finite element model, at block 122.

At block 110 of the integrated workflow 100, a volume of generated fracture may be calculated. The volume of generated fracture calculated at block 110 may correspond to a volume of fluid with cuttings accommodated and injected into the fracture. In one or more embodiments, the volume of generated fracture calculated at block 110 may depend on fracture's width, length, and/or height. At block 124 coupled with block 110, input data for calculation of the volume of generated fracture may be determined. In one or more embodiments, the input data may comprise: a value of fracture opening/width; a value of fracture's height that is constrained by cap integrity; and a value of fracture's length that is constrained by fault reactivation.

For certain embodiments, choice of a plane location of an injection well may be based on the preferred value of effective stress ratio. The principal stress ratio (PSR) utilized herein represents a ratio between a minimum principal effective stress Sₘᵢₙ and a maximum principal effective stress Sₘₐₓ. The sign convention of rock mechanics is adopted in the present disclosure, i.e., the compressive stress is positive and the tensile stress is negative. The definition of effective stress follows the definition from Terzaki's theory of porous elasticity. In one or more embodiments, the PSR represents the discrepancy between two principal stress components, i.e., the minimum principal effective stress Sₘᵢₙ and the maximum principal effective stress Sₘₐₓ. The PSR γ utilized herein is expressed as:

$$γ = \vert \frac{{S}_{min}}{{S}_{max}} \vert , {S}_{max} \neq 0. \qquad ( 1 )$$

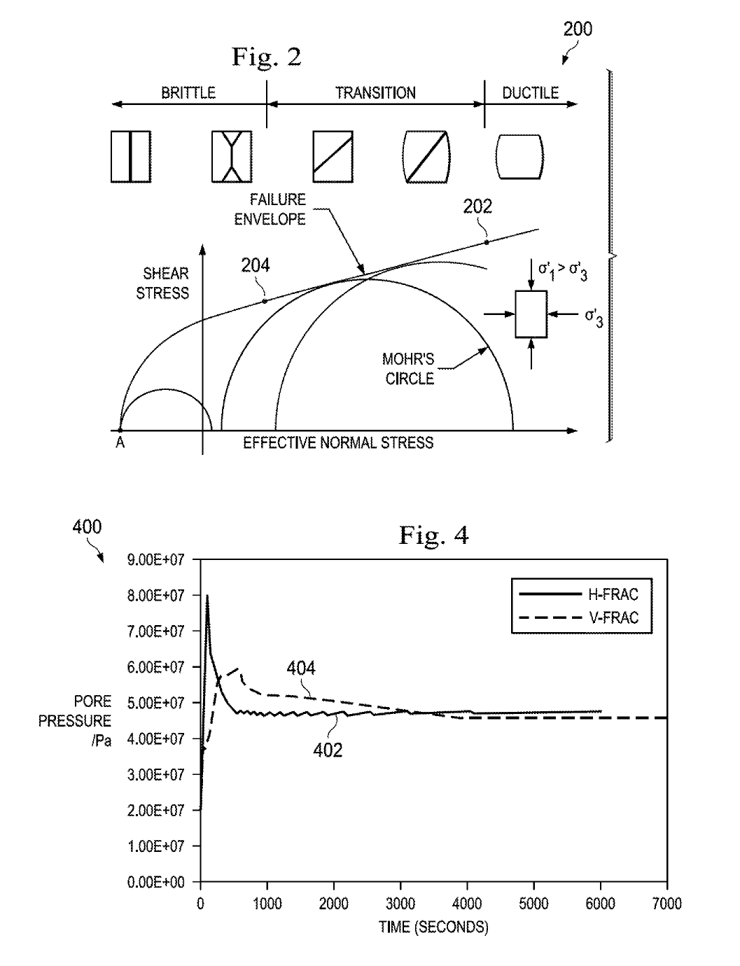

In one or more embodiments, adoption of the PSR can be based on the experimental phenomena. FIG. 2 is an example graph 200 showing a brittle and ductile failure of a shale rock with variation of a shear stress, according to certain embodiments of the present disclosure. It can be observed from FIG. 2 that the ductile failure of shale rock may occur at point 202 when effective normal stress becomes high, and the brittle failure may occur at point 204 when effective normal stress becomes low. As it is known from solid mechanics, the effective normal stress is the 3^{rd} stress invariant I3, and the shear stress is a function of the second invariant J2 of deviatoric stress tensor.

In one or more embodiments, the smaller the value of PSR defined by equation (1) is, the larger the existing shear stress value would be in the initial geostress field, and consequently, the easier the fracturing of the rock formation would be. Therefore, the injection well should be selected at the region that has the minimum value of PSR defined by equation (1).

It should be noted that the reason for not choosing a factor of shear stress for determining the location of injection well is that the calculation of effective stress ratio in equation (1) is much easier than that of a shear stress factor represented by the stress invariant J2, while final results for the choice of location of the injection well are close to each other. In one or more embodiments, based on the cost-efficiency consideration, it is adopted in the present disclosure the version of effective stress ratio defined by equation (1) as the index for choosing location of the injection well. In one or more embodiments, 3-D elastoplastic stress analysis can be performed to obtain 3-D stress distribution on nodes of a 3-D field. A user subroutine can be also utilized to further calculate the effective stress ratio from the solution of the stress distribution for the given field.

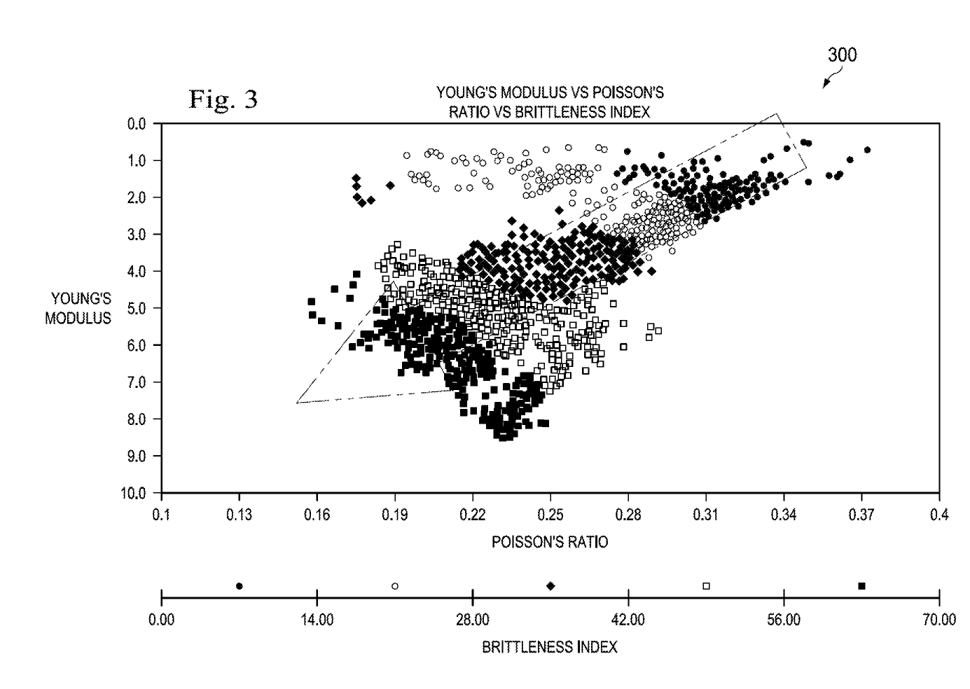

For certain embodiments, choice of TVD interval of a perforation section along a trajectory of the injection well may be based on a brittleness index. The brittleness index (BI) can be expressed as:

$$B I = \frac{E}{v} , \qquad ( 2 )$$

where E is a Young's modulus and vis a Poisson's ratio. Thus, the brittleness index defined by equation (2) is proportional to the value of Young's modulus and inverse proportional to the value of Poisson's ratio. The brittleness index defined by equation (2) expresses the experimental phenomena illustrated by graph 300 in FIG. 3 that shows the brittleness index as a function of the Young's modulus (YM) and the Poisson's ratio (PR).

For certain embodiments, the final determination of the TVD interval of cutting reinjection perforation section may be determined together with the TVD interval of cap. CRI requires the cap interval where the value of brittleness index defined by equation (2) is higher, which is easier to crack. On the other hand, the cap interval requires the place where the value of brittleness index defined by equation (2) is lower, which is harder to crack. In order to fulfill these opposite requirements, 1-D analysis may be utilized to derive the value of Young's modulus and Poisson's ratio from, for example, sonic logging data.

For certain embodiments, having the plane location of the well and TVD interval of the injection section been determined, the next task of the workflow 100 illustrated in FIG. 1 is to perform analysis on hydraulic fracturing. In one or more embodiments, the analysis on hydraulic fracturing may comprise two parts: (i) determination of the value of injection rate as well as the value of injection pressure at a bottom hole, and (ii) performing analysis on the cap integrity.

In order to fulfill the task of determining the value of injection rate and the value of injection pressure efficiently and accurately, sub-modeling techniques can be adopted in the present disclosure. Due to the requirement of accuracy for capturing the stress concentration around the fracture in a 3-D plane, a finer mesh may be required for discretization of the model. In one or more embodiments, the concept of the sub-modeling technique includes usage of a large-scale global model to produce boundary conditions for a smaller scale sub-model. In this way, the hierarchical levels of the sub-model are not limited. By using this approach, a highly inclusive field-scale analysis can be linked to very detailed stress analysis at a much smaller borehole scale. The benefits are bidirectional, with both the larger and smaller scale simulations benefiting from the linkage.

In one or more embodiments, the submodel-1 may be designed for fracturing analysis in horizontal direction, and the submodel-2 may be designed for fracturing analysis in vertical direction. Two sets of results of injection pressure variation may be obtained with the submodel-1 and the submodel-2. For a given set of values of injection rate, the curve of injection pressure versus injection rate can be obtained. The obtained sets of curves may indicate the lower bound of IPW required for initiating a fracture and the value of injection pressure required to maintain fracture propagation. A value of fracture opening/width for a given value of injection pressure and injection rate can be also obtained. Finally, an upper bound of IPW may be determined based on numerical results of hydraulic fracturing. The peak values of injection for the submodel-1 and the submodel-2 may be compared.

In one or more embodiments, during injection, horizontal (H) and vertical (V) fractures may grow simultaneously, but at different speeds. FIG. 4 illustrates an example graph 400 of comparison between injection pressure variation and time for H fracture (plot 402) and V fracture (plot 404). Since a fracture develops in a direction of a lowest pressure, it can be observed from FIG. 4 that the fracture may initially develop in the vertical direction (i.e., V fracture is first formed), and then the fracture may develop in the horizontal direction (i.e., H fracture is developed following V fracture). The example graph 400 in FIG. 4 may be utilized for determining the lower bound of IPW as a value of injection pressure at the stage of stable fracture propagation.

For certain embodiments, cap integrity analysis may be performed on the basis of aforementioned submodel-2, which is designed for hydraulic fracturing simulation in vertical direction. The set of results related to cap integrity analysis may predict the behavior of fluid migration, and verify the upper bound of IPW.

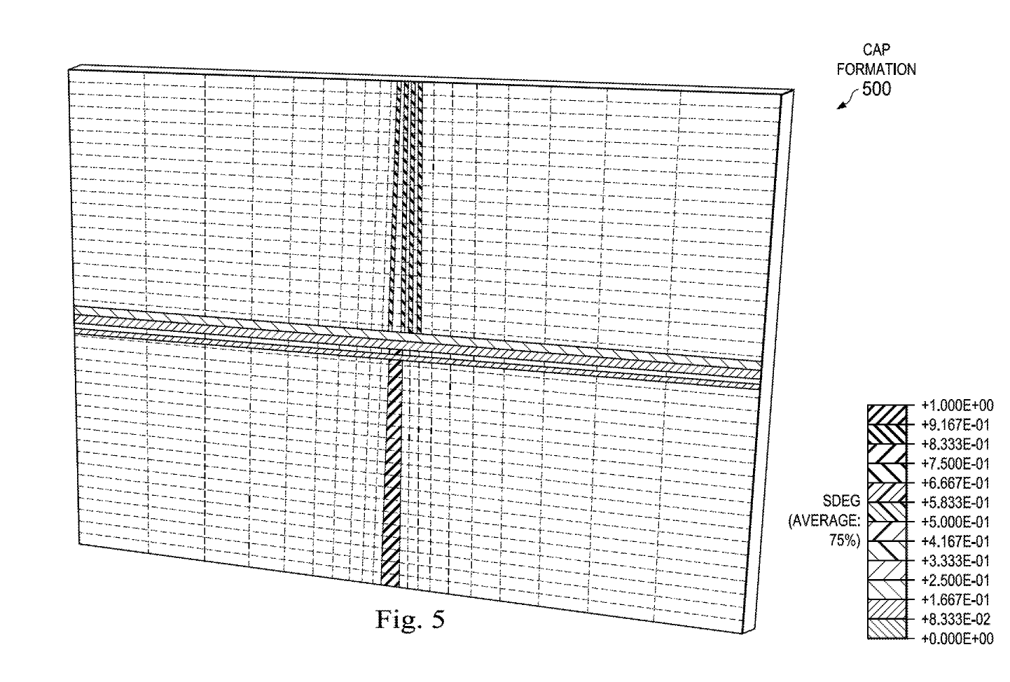

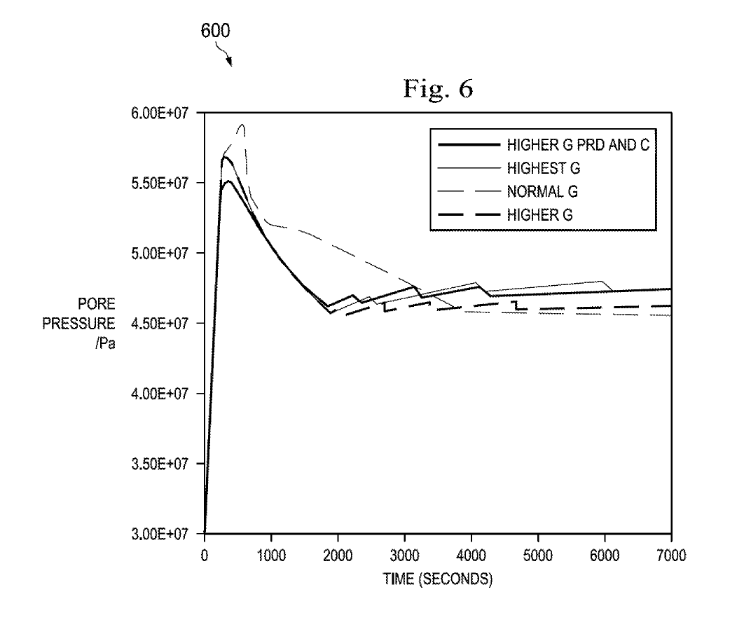

In one or more embodiments, the submodel-2 (e.g., final element model (FEM) for vertical fracture analysis) can be adopted for purpose of estimation on cap formation, with addition of a cap formation at the upper part of the model. As shown in FIG. 5 illustrating FEM model for cap integrity estimation characterized by stiffness degradation (SDEG), the cap formation 500 may be directly positioned above the injection formation. With variations of values of parameters G (fracture energy), Prd (Poisson's ratio) and C (cohesive strength) at cap formation, curves of variation of injection pressure versus time for stable fracture propagation stage are illustrated in an example graph 600 in FIG. 6. Alongside diagrams shown in FIG. 6 for different parameters, numerical results of fracture propagation are verified. It is determined that the fracture propagation stopped at a bottom of the cap formation, indicating that the cap integrity is ensured.

According to certain embodiments, aims of fault reactivation analysis are dual. The first aim is related to estimation of fluid migration. The second aim is related to estimation of maximum intensity level of seismic behavior. In the following, these two aspects are described separately.

In one or more embodiments, as discussed, fluid mitigation may be due to fault reactivation. The following assumptions and simplifications are adopted in the present disclosure for the geomechanical modeling of the fluid mitigation resulted from fault reactivation. First, the plane-strain model can be used for the purpose of simplification. The propagation process of injection-generated fractures within formation other than fault can be neglected. Further, injection-generated fracture is connected to the fault at one side but would not cross the fault. For accuracy and efficiency of the model, formations outside the fault area are taken as poroelastic material, and fault material is modeled as poroelasto-plastic material. The plastic strain-dependent permeability can be adopted for the fault material. Thus, the permeability of material of fault may grow with development of plastic strain. In this way, fluid migration may be modeled together with the development of region of plastic deformation. For accuracy and efficiency of the analysis, the process of fluid migration can be modeled as the transient process of porous flow.

In one or more embodiments, numerical results of mechanical variables can be visualized, such as: distribution of plastic region that shows the scope of fault being reactivated, contour of pore pressure within the fault, and contour of von-Mises equivalent stress and displacement field of the whole model. According to embodiments of the present disclosure, with the modeling and numerical results described above, scenarios of fluid migration related to the injection pressure can be simulated and predicted.

For certain embodiments, a maximum intensity level of seismic behavior of the fault may be estimated. The following techniques are used in the model of the present disclosure to determine the maximum intensity level of seismic behavior. In one or more embodiments, the level of magnitude of seismic activity resulted from fault reactivation may be calculated analytically with an empirical equation. The input data for calculation on magnitude of seismic activity may include the numerical solution of displacement discrepancy. In an embodiment, the solution of displacement discrepancy may be obtained numerically with finite element calculation of a simplified model. In this model, values of Young's modulus may be assigned to each part of the model in a way that the resultant displacement discrepancy is localized to the region of fault modeled in the analysis. In one or more embodiments, the formation consisting of the upper side of the fault is modeled as a ‘kinematic admissible’. In this way, the model can simulate the kinematic behavior of a seismic activity. For accuracy and efficiency of the seismic analysis, the porous flow occurred in the fault can be regarded as static porous flow process. The analysis presented herein can predict the maximum level of magnitude of possible seismic activity.

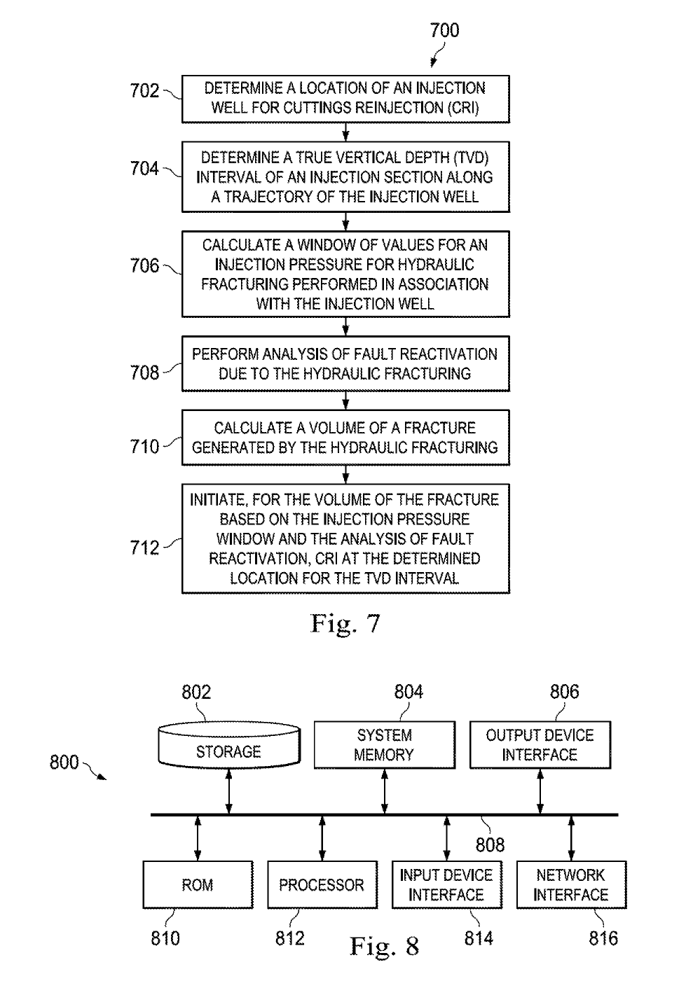

Discussion of an illustrative method of the present disclosure will now be made with reference to FIG. 7, which is a flow chart 700 of a method for performing feasibility study of CRI, according to certain embodiments of the present disclosure. The method begins at 702 by determining a location of an injection well for CRI. At 704, a TVD interval of an injection section along a trajectory of the injection well may be determined. At 706, a window of values for an injection pressure for hydraulic fracturing performed in association with the injection well may be calculated. At 708, analysis of fault reactivation due to the hydraulic fracturing may be performed. At 710, a volume of a fracture generated by the hydraulic fracturing may be calculated. At 712, or the volume of the fracture based on the injection pressure window and the analysis of fault reactivation, CRI may be initiated at the determined location for the TVD interval.

FIG. 8 is a block diagram of an illustrative computing system 800 in which embodiments of the present disclosure may be implemented adapted for performing feasibility study of CRI. For example, the operations of framework 100 from FIG. 1 and the operations of method 700 of FIG. 7, as described above, may be implemented using the computing system 800. The computing system 800 can be a computer, phone, personal digital assistant (PDA), or any other type of electronic device. Such an electronic device includes various types of computer readable media and interfaces for various other types of computer readable media. As shown in FIG. 8, the computing system 800 includes a permanent storage device 802, a system memory 804, an output device interface 806, a system communications bus 808, a read-only memory (ROM) 810, processing unit(s) 812, an input device interface 814, and a network interface 816.

The bus 808 collectively represents all system, peripheral, and chipset buses that communicatively connect the numerous internal devices of the computing system 800. For instance, the bus 808 communicatively connects the processing unit(s) 812 with the ROM 810, the system memory 804, and the permanent storage device 802.

From these various memory units, the processing unit(s) 812 retrieves instructions to execute and data to process in order to execute the processes of the subject disclosure. The processing unit(s) can be a single processor or a multi-core processor in different implementations.

The ROM 810 stores static data and instructions that are needed by the processing unit(s) 812 and other modules of the computing system 800. The permanent storage device 802, on the other hand, is a read-and-write memory device. This device is a non-volatile memory unit that stores instructions and data even when the computing system 800 is off. Some implementations of the subject disclosure use a mass-storage device (such as a magnetic or optical disk and its corresponding disk drive) as the permanent storage device 802.

Other implementations use a removable storage device (such as a floppy disk, flash drive, and its corresponding disk drive) as the permanent storage device 802. Like the permanent storage device 802, the system memory 804 is a read-and-write memory device. However, unlike the storage device 802, the system memory 804 is a volatile read-and-write memory, such a random access memory. The system memory 804 stores some of the instructions and data that the processor needs at runtime. In some implementations, the processes of the subject disclosure are stored in the system memory 804, the permanent storage device 802, and/or the ROM 810. For example, the various memory units include instructions for computer aided pipe string design based on existing string designs in accordance with some implementations. From these various memory units, the processing unit(s) 812 retrieves instructions to execute and data to process in order to execute the processes of some implementations.

The bus 808 also connects to the input and output device interfaces 814 and 806. The input device interface 814 enables the user to communicate information and select commands to the computing system 800. Input devices used with the input device interface 814 include, for example, alphanumeric, QWERTY, or T9 keyboards, microphones, and pointing devices (also called “cursor control devices”). The output device interfaces 806 enables, for example, the display of images generated by the computing system 800. Output devices used with the output device interface 806 include, for example, printers and display devices, such as cathode ray tubes (CRT) or liquid crystal displays (LCD). Some implementations include devices such as a touchscreen that functions as both input and output devices. It should be appreciated that embodiments of the present disclosure may be implemented using a computer including any of various types of input and output devices for enabling interaction with a user. Such interaction may include feedback to or from the user in different forms of sensory feedback including, but not limited to, visual feedback, auditory feedback, or tactile feedback. Further, input from the user can be received in any form including, but not limited to, acoustic, speech, or tactile input. Additionally, interaction with the user may include transmitting and receiving different types of information, e.g., in the form of documents, to and from the user via the above-described interfaces.

Also, as shown in FIG. 8, the bus 808 also couples the computing system 800 to a public or private network (not shown) or combination of networks through a network interface 816. Such a network may include, for example, a local area network (“LAN”), such as an Intranet, or a wide area network (“WAN”), such as the Internet. Any or all components of the computing system 800 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD−RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself. Accordingly, the operations of framework 100 from FIG. 1 and the operations of method 700 of FIG. 7, as described above, may be implemented using the computing system 800 or any computer system having processing circuitry or a computer program product including instructions stored therein, which, when executed by at least one processor, causes the processor to perform functions relating to these methods.

As used in this specification and any claims of this application, the terms “computer”, “server”, “processor”, and “memory” all refer to electronic or other technological devices. These terms exclude people or groups of people. As used herein, the terms “computer readable medium” and “computer readable media” refer generally to tangible, physical, and non-transitory electronic storage mediums that store information in a form that is readable by a computer.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs implemented on the respective computers and having a client-server relationship to each other. In some embodiments, a server transmits data (e.g., a web page) to a client device (e.g., for purposes of displaying data to and receiving user input from a user interacting with the client device). Data generated at the client device (e.g., a result of the user interaction) can be received from the client device at the server.

It is understood that any specific order or hierarchy of operations in the processes disclosed is an illustration of exemplary approaches. Based upon design preferences, it is understood that the specific order or hierarchy of operations in the processes may be rearranged, or that all illustrated operations be performed. Some of the operations may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Furthermore, the illustrative methods described herein may be implemented by a system including processing circuitry or a computer program product including instructions which, when executed by at least one processor, causes the processor to perform any of the methods described herein.

A computer-implemented method for performing feasibility study of CRI has been described in the present disclosure and may generally include: determining a location of an injection well for CRI; determining a TVD interval of an injection section along a trajectory of the injection well; calculating a window of values for an injection pressure for hydraulic fracturing performed in association with the injection well; performing analysis of fault reactivation due to the hydraulic fracturing; calculating a volume of a fracture generated by the hydraulic fracturing; and initiating, for the volume of the fracture based on the injection pressure window and the analysis of fault reactivation, CRI at the determined location for the TVD interval. Further, a computer-readable storage medium with instructions stored therein has been described, instructions when executed by a computer cause the computer to perform a plurality of functions, including functions to: determine a location of an injection well for CRI; determine a TVD interval of an injection section along a trajectory of the injection well; calculate a window of values for an injection pressure for hydraulic fracturing performed in association with the injection well; perform analysis of fault reactivation due to the hydraulic fracturing; calculate a volume of a fracture generated by the hydraulic fracturing; and generate an order for initiating, for the volume of the fracture based on the injection pressure window and the analysis of fault reactivation, CRI at the determined location for the TVD interval.

For the foregoing embodiments, the method or functions may include any one of the following operations, alone or in combination with each other: Deriving the Young's modulus and the Poisson's ratio from logging data related to the injection well; Calculating the window of values for the injection pressure comprises deriving a lower bound of the window based on analysis of initiation and propagation of the hydraulic fracturing, and deriving an upper bound of the window greater than the lower bound based on estimation of cap integrity associated with fluid migration during the hydraulic fracturing; Deriving the lower bound and the upper bound is based on a first sub-model designed for analysis of the hydraulic fracturing in a first direction and on a second sub-model designed for analysis of the hydraulic fracturing in a second direction orthogonal to the first direction; Performing the analysis of fault reactivation associated with the hydraulic fracturing comprises performing the analysis of fault reactivation by estimating fluid migration during the hydraulic fracturing, and estimating a magnitude of a seismic activity associated with the fault reactivation; Estimating the magnitude of the seismic activity comprises determining a numerical solution of displacement discrepancy across the fault based on a finite element model of the fracture, and calculating analytically the magnitude of the seismic activity; Calculating the volume of the fracture comprises calculating a volume of a fluid injected with the cuttings reinjection; Calculating the volume of the fracture comprises determining a length of the fracture based on cap integrity associated with fluid migration during the hydraulic fracturing, and determining a width of the fracture based on the analysis of fault reactivation.

The location of the injection well is determined using a value of an effective stress ratio based on a stress distribution within a formation associated with the injection well; The effective stress ratio is a ratio between a minimum principal effective stress and a maximum principal effective stress within the formation; The determination of the TVD interval is based on a brittleness index proportional to Young's modulus and inverse proportional to Poisson's ratio; The logging data comprise at least one of sonic data or gamma ray data.

Likewise, a system for performing feasibility study of CRI has been described and include at least one processor and a memory coupled to the processor having instructions stored therein, which when executed by the processor, cause the processor to perform functions, including functions to: determine a location of an injection well for CRI; determine a TVD interval of an injection section along a trajectory of the injection well; calculate a window of values for an injection pressure for hydraulic fracturing performed in association with the injection well; perform analysis of fault reactivation due to the hydraulic fracturing; calculate a volume of a fracture generated by the hydraulic fracturing; and generate an order for initiating, for the volume of the fracture based on the injection pressure window and the analysis of fault reactivation, CRI at the determined location for the TVD interval.

For any of the foregoing embodiments, the system may include any one of the following elements, alone or in combination with each other: the functions performed by the processor include functions to determine the location of the injection well using a value of an effective stress ratio based on a stress distribution within a formation associated with the injection well; the functions performed by the processor include functions to determine the TVD interval based on a brittleness index proportional to Young's modulus and inverse proportional to Poisson's ratio; the functions performed by the processor include functions to derive the Young's modulus and the Poisson's ratio from logging data related to the injection well; the functions performed by the processor include functions to derive a lower bound of the window based on analysis of initiation and propagation of the hydraulic fracturing, and derive an upper bound of the window greater than the lower bound based on estimation of cap integrity associated with fluid migration during the hydraulic fracturing; the functions performed by the processor include functions to derive the lower bound and the upper bound based on a first sub-model designed for analysis of the hydraulic fracturing in a first direction and on a second sub-model designed for analysis of the hydraulic fracturing in a second direction orthogonal to the first direction; the functions performed by the processor include functions to perform the analysis of fault reactivation by estimating fluid migration during the hydraulic fracturing, and estimate a magnitude of a seismic activity associated with the fault reactivation; the functions performed by the processor include functions to determine a numerical solution of displacement discrepancy across the fault based on a finite element model of the fracture, and calculate analytically the magnitude of the seismic activity; the functions performed by the processor for calculating the volume of the fracture include functions to calculate a volume of a fluid injected with the cuttings reinjection; the functions performed by the processor include functions to determine a length of the fracture based on cap integrity associated with fluid migration during the hydraulic fracturing, and determine a width of the fracture based on the analysis of fault reactivation.

Embodiments of the present disclosure establish an integrated workflow for feasibility study of CRI process in the framework of 3-D geomechanics. Various numerical solutions such as stress distribution, fracture initiation and propagation, cap integrity, and fault reactivation obtained with 3-D finite element modeling, 2-D finite element modeling, and 1-D analytical modeling, respectively are used in the decision-making process of CRI. In comparison with the conventional workflow of CRI that is mainly based on empirical methods, the integrated workflow for feasibility study of CRI presented herein has higher accuracy and higher efficiency.

A process for 3-D calculation of IPW based on geomechanical analysis of hydraulic fracturing is presented in this disclosure as the integral part of workflow for feasibility study of CRI process. Finite element sub-modeling techniques are adopted herein for accuracy and efficiency of the analysis of hydraulic fracturing. Two sub-models are presented in this disclosure for fracture initiation and propagation in horizontal and vertical directions, respectively. In this way, the computational burden caused by analysis of hydraulic fracturing is reduced significantly.

Estimation on cap integrity is also presented in this disclosure as the integral part of workflow for feasibility study of CRI process. The sub-model established for analysis of hydraulic fracturing in vertical direction is utilized. The cap integrity is validated herein by: checking numerical solution for fracture propagation, wherein cap integrity is ensured with the phenomena that the induced fracture stops at the bottom of the cap formation; and checking the value of injection pressure for initiating fracture at the cap formation by setting the injection point at the bottom of the cap formation. In one or more embodiments, cap integrity can be ensured as long as the injection pressure required to generate fracture at the cap formation is significantly higher than the value of injection pressure for fracture propagation at the stable propagation stage.

A process of fault reactivation analysis is further presented in this disclosure as the integral part of workflow for feasibility study of CRI process. Fluid migration and seismic analysis are performed in this process. 2-D plane strain finite element model can be utilized for the purpose of accuracy and efficiency. Semi-analytical method is used herein for calculation of magnitude of seismicity by using the numerical solution of displacement discrepancy across fault as input to the analytical equations.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

While specific details about the above embodiments have been described, the above hardware and software descriptions are intended merely as example embodiments and are not intended to limit the structure or implementation of the disclosed embodiments. For instance, although many other internal components of computer system 800 are not shown, those of ordinary skill in the art will appreciate that such components and their interconnection are well known.

In addition, certain aspects of the disclosed embodiments, as outlined above, may be embodied in software that is executed using one or more processing units/components. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives, optical or magnetic disks, and the like, which may provide storage at any time for the software programming.

Additionally, the flowchart and block diagrams in the figures illustrate the architecture, functionality, and operation of possible implementations of systems, methods and computer program products according to various embodiments of the present disclosure. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The above specific example embodiments are not intended to limit the scope of the claims. The example embodiments may be modified by including, excluding, or combining one or more features or functions described in the disclosure.

1. A computer-implemented method for performing feasibility study of cuttings reinjection (CRI), the method comprising:
determining a location of an injection well for CRI;
determining a true vertical depth (TVD) interval of an injection section along a trajectory of the injection well;
calculating a window of values for an injection pressure for hydraulic fracturing performed in association with the injection well;
performing analysis of fault reactivation due to the hydraulic fracturing;
calculating a volume of a fracture generated by the hydraulic fracturing; and
initiating, for the volume of the fracture based on the injection pressure window and the analysis of fault reactivation, CRI at the determined location for the TVD interval.

2. The method of claim 1, wherein the location of the injection well is determined using a value of an effective stress ratio based on a stress distribution within a formation associated with the injection well.

3. The method of claim 2, wherein the effective stress ratio is a ratio between a minimum principal effective stress and a maximum principal effective stress within the formation.

4. The method of claim 1, wherein the determination of the TVD interval is based on a brittleness index proportional to Young's modulus and inverse proportional to Poisson's ratio.

5. The method of claim 4, further comprising:
deriving the Young's modulus and the Poisson's ratio from logging data related to the injection well.

6. The method of claim 5, wherein the logging data comprise at least one of sonic data or gamma ray data.

7. The method of claim 1, wherein calculating the window of values for the injection pressure comprises:
deriving a lower bound of the window based on analysis of initiation and propagation of the hydraulic fracturing; and
deriving an upper bound of the window greater than the lower bound based on estimation of cap integrity associated with fluid migration during the hydraulic fracturing.

8. The method of claim 7, wherein:
the lower bound is based on a value of the injection pressure at a stage of stable propagation of the hydraulic fracturing, and the upper bound is based on a largest value of the injection pressure with a defined injection rate; or
deriving the lower bound and the upper bound is based on a first sub-model designed for analysis of the hydraulic fracturing in a first direction and on a second sub-model designed for analysis of the hydraulic fracturing in a second direction orthogonal to the first direction.

9. (canceled)

10. The method of claim 1, wherein performing the analysis of fault reactivation associated with the hydraulic fracturing comprises:
performing the analysis of fault reactivation by estimating fluid migration during the hydraulic fracturing; and
estimating a magnitude of a seismic activity associated with the fault reactivation.

11. The method of claim 10, wherein estimating the magnitude of the seismic activity comprises:
determining a numerical solution of displacement discrepancy across the fault based on a finite element model of the fracture; and
calculating analytically the magnitude of the seismic activity.

12. The method of claim 1, wherein:
calculating the volume of the fracture comprises calculating a volume of a fluid injected with the cuttings reinjection; or
calculating the volume of the fracture comprises determining a length of the fracture based on cap integrity associated with fluid migration during the hydraulic fracturing, and determining a width of the fracture based on the analysis of fault reactivation.

13. (canceled)

14. A system for performing feasibility study of cuttings reinjection (CRI), the system comprising:
at least one processor; and
a memory coupled to the processor having instructions stored therein, which when executed by the processor, cause the processor to perform functions, including functions to:
determine a location of an injection well for CRI;
determine a true vertical depth (TVD) interval of an injection section along a trajectory of the injection well;
calculate a window of values for an injection pressure for hydraulic fracturing performed in association with the injection well;
perform analysis of fault reactivation due to the hydraulic fracturing;
calculate a volume of a fracture generated by the hydraulic fracturing; and
generate an order for initiating, for the volume of the fracture based on the injection pressure window and the analysis of fault reactivation, CRI at the determined location for the TVD interval.

15. The system of claim 14, wherein the functions performed by the processor include functions to:
determine the location of the injection well using a value of an effective stress ratio based on a stress distribution within a formation associated with the injection well; or
determine the TVD interval based on a brittleness index proportional to Young's modulus and inverse proportional to Poisson's ratio, and derive the Young's modulus and the Poisson's ratio from logging data related to the injection well.

16. (canceled)

17. The system of claim 14, wherein the functions performed by the processor include functions to:
derive a lower bound of the window based on analysis of initiation and propagation of the hydraulic fracturing; and
derive an upper bound of the window greater than the lower bound based on estimation of cap integrity associated with fluid migration during the hydraulic fracturing.

18. The system of claim 17, wherein the functions performed by the processor include functions to derive the lower bound and the upper bound based on a first sub-model designed for analysis of the hydraulic fracturing in a first direction and on a second sub-model designed for analysis of the hydraulic fracturing in a second direction orthogonal to the first direction.

19. The system of claim 14, wherein the functions performed by the processor include functions to:
perform the analysis of fault reactivation by estimating fluid migration during the hydraulic fracturing; and
estimate a magnitude of a seismic activity associated with the fault reactivation.

20. The system of claim 14, wherein the functions performed by the processor for calculating the volume of the fracture include functions to calculate a volume of a fluid injected with the cuttings reinjection.

21. The system of claim 14, wherein the functions performed by the processor include functions to:
determine a length of the fracture based on cap integrity associated with fluid migration during the hydraulic fracturing; and
determine a width of the fracture based on the analysis of fault reactivation.

22. A computer-readable storage medium having instructions stored therein, which when executed by a computer cause the computer to perform a plurality of functions, including functions to:
determine a location of an injection well for cuttings reinjection (CRI);
determine a true vertical depth (TVD) interval of an injection section along a trajectory of the injection well;
calculate a window of values for an injection pressure for hydraulic fracturing performed in association with the injection well;
perform analysis of fault reactivation due to the hydraulic fracturing;
calculate a volume of a fracture generated by the hydraulic fracturing; and
generate an order for initiating, for the volume of the fracture based on the injection pressure window and the analysis of fault reactivation, CRI at the determined location for the TVD interval.

23. The computer-readable storage medium of claim 22, wherein the instructions further perform functions to:
perform the analysis of fault reactivation by estimating fluid migration during the hydraulic fracturing; and
estimate a magnitude of a seismic activity associated with the fault reactivation.
